(19) United States
(12) Patent Application Publication
(10) Pub. No.: US 2026/0321141 A1
(43) Pub. Date: Oct. 15, 2026

(54) Computer-Implemented Method and Controller for Determining a Required Safety Integrity Level for Safety-Related Vehicle Functions

(71) Applicant: Robert Bosch GmbH, Stuttgart (DE)

(72) Inventor: Andreas Heyl, Weil Der Stadt (DE)

(21) Appl. No.: 18/880,823

(22) PCT Filed: Jul. 3, 2023
(86) PCT No.: PCT/EP2023/068180

§ 371 Date: Jan. 2, 2025

(30) Foreign Application Priority Data
Jul. 6, 2022 (DE) 10 2022 206 924.2

(51) Int. Cl. G08G 1/16

(52) U.S. Cl. CPC G08G 1/166

(57) ABSTRACT

A method is for determining a required safety integrity level for safety-related vehicle functions of a model of the surroundings of a vehicle. The model includes a plurality of safety-related vehicle functions. The method includes providing at least one infrastructure data signal which represents infrastructure data and at least one vehicle sensor data, signal which represents vehicle sensor data, each piece of vehicle sensor data signal being determined for the plurality of safety-related vehicle functions. The method further includes determining a safety integrity level for the plurality of safety-related vehicle functions on the basis of the provided at least one infrastructure data signal and the at least one vehicle sensor data signal. A first weighting is added to the vehicle sensor data signal, and a second weighting is added to the infrastructure data signal in order to determine the required safety integrity level for the plurality of safety-related vehicle functions.

The invention relates to a computer-implemented method for determining a required safety integrity level for safety-related vehicle functions of a model of the surroundings having a plurality of safety-related vehicle functions.

Furthermore, the invention relates to a controller for determining a required safety integrity level for safety-related vehicle functions of a model of the surroundings having a plurality of safety-related vehicle functions.

Safety standards such as ISO 26262 describe the recommended procedure for developing safety-related functions. A first step is to determine the safety integrity of functions on the basis of a risk analysis, e.g. Hazard Analysis and Risk Assessment (HARA) in ISO 26262. This is carried out during the development time on the basis of assumptions about the use of the function or system containing the function in question.

In ISO 26262, for example, this is done via the parameters of a probability of occurrence of a situation in which a malfunction could be hazardous, a possible controllability of this malfunction, and a severity of the effect if this malfunction cannot be controlled in this situation. The assessment then provides a necessary level of safety integrity (e.g. ASIL) of a function on the basis of which the necessary development processes and safety mechanisms are derived from the safety standard.

This results in both applicable design and test methods for the hardware and software as well as necessary ASIL compliance of hardware components on which the safety-related software runs later, which can be achieved, for example, by extensive diagnostics and the provision of hardware redundancy.

DE102015200422A1 discloses a vehicle control and calculation system, comprising an in-vehicle task controller, a vehicle-specific calculation manager on a cloud network and a wireless data channel, which couples the task controller and the cloud network, wherein the task controller performs operational tasks in the vehicle using data-related resources in the cloud network, wherein upon initiation of one of the operational tasks, the task controller sends an exchange signal to the calculation manager as a resource request, wherein the calculation manager calls at least one cloud-based agent from a database of predetermined agents in response to the exchange signal, and wherein the task controller completes the operational task by communicating with the called agent.

DE102019214453A1 discloses a method for safely performing a function provided by means of a motor vehicle, comprising the steps of: receiving infrastructure data signals which represent infrastructure data, which are intended for a function provided by means of a motor vehicle, receiving safety condition signals, which represent at least one safety condition, which must be met to allow the function to execute on the basis of the infrastructure data, checking whether the at least one safety condition is satisfied, determining whether the function may be performed on the basis of the infrastructure data, on the basis of a result of the checking, generating result signals, which represent a result of the determination and outputting the generated result signals.

Typically, the ASIL of a function is determined and fixedly assigned during the development time on the basis of assumptions about the “worst case” situations. However, by considering the plurality of possible situations, it is easily understood that the malfunction of a safety-related function is not at all dangerous in many of these situations. This applies to both primary functions such as actuator control, e.g., unwanted motor stop while stationary, as well as secondary functions such as environmental perception, e.g., object detection in remote areas during a slow drive.

On the other hand, incorrect or insufficient specification of safety requirements during the design can also mean that in specific situations, functions for generating the model of the surroundings, e.g. sensor coverage of a specific field of vision, are classified as having too low a safety criticality and are therefore not executed with sufficient safety or reliability.

The invention thus addresses the problem of providing an improved method and controller for determining a required safety integrity level for safety-related vehicle functions of a model of the surroundings comprising a plurality of safety-related vehicle functions, which enable a safety integrity level of a safety-related vehicle function to be determined depending on the situation.

The task is solved with a computer-implemented method for determining a required safety integrity level for safety-related vehicle functions of a model of the surroundings having a plurality of safety-related vehicle functions with the features of claim 1.

Moreover, the task is solved with a controller for determining a required safety integrity level for safety-related vehicle functions of a model of the surroundings having a plurality of safety-related vehicle functions with the features of claim 13.

Furthermore, the task is solved with a computer program having the features of claim 14 and a computer-readable data storage medium having the features of claim 15.

### DISCLOSURE OF THE INVENTION

The present invention relates to a computer-implemented method for determining a required safety integrity level for safety-related vehicle functions of a model of the surroundings of the vehicle, said model having a plurality of safety-related vehicle functions.

The method comprises providing at least one infrastructure data signal which represents infrastructure data and at least one vehicle sensor data signal which represents vehicle sensor data, each piece of vehicle sensor data being determined for the plurality of safety-related vehicle functions.

The method further comprises determining a safety integrity level for the plurality of safety-related vehicle functions on the basis of the provided at least one infrastructure data signal and the at least one vehicle sensor data signal, wherein a first weighting is added to the at least one vehicle sensor data signal, and a second weighting is added to the at least one infrastructure data signal in order to determine the required safety integrity level for the plurality of safety-related vehicle functions.

For example, the safety integrity level may be calculated by a weighted sum of the at least one vehicle sensor data signal and the at least one vehicle sensor data signal.

The safety integrity level of the vehicle function represents or describes a degree or level of safety integrity of the vehicle function. The safety integrity of the vehicle function refers in particular to a reliability of the vehicle function, which can be determined, for example, by means of a risk assessment.

The present invention further creates a controller for determining a required safety integrity level for safety-related vehicle functions of a model of the surroundings having a plurality of safety-related vehicle functions.

The controller comprises a first means for providing at least one infrastructure data signal which represents infrastructure data and at least one vehicle sensor data signal which represents vehicle sensor data, each piece of vehicle sensor data being determined for the plurality of safety-related vehicle functions.

Moreover, the controller comprises a second means for determining a required safety integrity level for the plurality of safety-related vehicle functions on the basis of the provided at least one infrastructure data signal and the at least one vehicle sensor data signal, wherein a first weighting is added to the at least one vehicle sensor data signal, and a second weighting is added to the at least one infrastructure data signal in order to determine the required safety integrity level for the plurality of safety-related vehicle functions.

The present invention further creates a computer program with program code to perform the method according to the invention when the computer program is executed on a computer, and a computer readable data carrier with program code of a computer program to perform the method according to the invention when the computer program is executed on a computer.

Typically, a safety-related function is implemented using software developed specifically for this purpose with the corresponding ASIL and on hardware developed specifically for this purpose with the corresponding ASIL. In traditional vehicle E/E architectures, there are therefore no advantages to implementing functions dynamically on hardware and with software with different ASILs, as the corresponding hardware and software are already available.

However, future vehicle E/E architectures will be highly networked with external systems such as cloud, edge, other vehicles, and/or smart devices. This offers the option of outsourcing functions externally. However, the ASIL of a function is a limitation for this outsourcing, as these external systems were often not developed according to a safety standard such as ISO 26262 and thus do not offer the necessary “ASIL compliance”.

One idea of the present invention is therefore to determine the relevant or critical and non-relevant or non-critical areas of the model of the surroundings during operation not only from the vehicle-directly or indirectly by detecting the scenario-but also to make them available locally via local information such as via a connection to a cloud, e.g., a static and/or dynamic map or spatial computing, to a local edge server or to a dedicated local transmission unit, e.g. a retrofit device at a traffic light.

In this way, a safety criticality of perception functions in certain areas around an ego vehicle can be better determined locally at a geographic location on the basis of current local perception or by statistical analysis of historical local measurement data.

This validated additional information allows incorrect estimates by the vehicle sensors to be corrected within the vehicle, thereby increasing safety. These incorrect estimates can be caused both by an incorrect perception of the situation by the vehicle and by an incorrect estimate of the possible critical events by the developer.

Thus, errors in the design, e.g., overlooking specific edge and corner cases, can also be compensated for locally at a later date, thereby increasing safety. This information can be validated extensively and over a long period of time, even during operation before it is released externally. This improves reliability and facilitates the safety argumentation of the overall system.

If the information is highly reliable, e.g. transmitted by metadata or otherwise guaranteed, the vehicle can also better implement the calculation of the environmental model, perception functions and/or sub-functions on the basis of the external specifications in areas that have been determined locally as non-safety-relevant, e.g. by providing less redundancy, suspending measurement cycles, reducing resolution, or completely dispensing with detection.

This temporarily frees up resources that can be used for other functions. A possible in-vehicle determination of the real-time security requirements could also be implemented more efficiently by this second, highly reliable path, or temporarily and/or locally dispensed with completely, whereby resources can also be freed up at least temporarily.

According to a preferred further development, it is provided that the at least one infrastructure data signal contains information as to which regional areas of the surroundings of the vehicle have which level of safety integrity. Thus, it can be determined to what extent the regional areas of the surroundings of the vehicle are safety critical.

According to another preferred further development, it is provided that the at least one infrastructure data signal comprises information about static obstacles, a traffic infrastructure, and/or dynamic objects.

For example, static obstacles may include falling stones adjacent to a slope, frequent occurrences of potholes in spring, lost freight, bicycles and/or scooters on the road adjacent to a bicycle or scooter parking lot, and/or hanging branches. For example, dynamic objects may be vehicles turning sharply from a roadway with poor visibility and/or a cycle path joining from the right on a sloping road.

According to a further preferred development, it is provided that the at least one infrastructure data signal comprises information about a type of objects occurring with a predetermined probability in regional areas of the surroundings of the vehicle and a type of objects not occurring with a predetermined probability in regional areas of the surroundings of the vehicle.

Frequently occurring objects may include, for example, trucks from a driveway into a company premises, motorcyclists at the weekend, children in front of a school, and/or people dressed up near a carnival parade. Objects that do not occur frequently may be, for example, pedestrians from an area inaccessible to persons, in particular due to a prohibition of access and/or physically inaccessible locations or walls or fences that cannot be crossed.

According to another preferred further development, it is provided that the at least one infrastructure data signal comprises information about a traffic density, a time, weather, light conditions, and/or a sun position. Thus, these circumstances may be included in determining the safety integrity level.

According to a further preferred development, it is provided, on the basis of the determined safety integrity level for the plurality of safety-related vehicle functions, data in particular, a control signal for controlling at least one vehicle sensor, is generated which represent the sensor modalities, in particular video, radar, lidar, ultrasonic, and/or microphone, with which regional areas of the surroundings of the vehicle are to be covered by vehicle sensors. This can advantageously improve the safety integrity level for the plurality of safety-related vehicle functions.

According to a further preferred development, it is provided that, on the basis of the determined safety integrity level for the plurality of safety-related vehicle functions, first data, in particular a control signal for controlling at least one vehicle sensor, is generated which represents the sensor redundancy, sensor resolution, and/or sensor measurement frequency with which regional areas of the vehicle's environment are to be covered. This ensures a more accurate sensor detection of a scenario by the safety-related vehicle function.

According to a preferred development, it is provided that, on the basis of the determined safety integrity level for the plurality of safety-related vehicle functions, second data, in particular a control signal, is generated for the plurality of safety-related vehicle functions for weighting perception functions, object models, and/or movement models regarding their suitability for sensing vehicle surroundings. This may in particular be carried out if different variants for a perception function are available.

According to a preferred development, it is provided that, on the basis of the determined safety integrity level for the plurality of safety-related vehicle functions, third data, in particular a control signal, is generated to select an algorithm type, in particular a Kalman filter or a deep learning based algorithm. This means that that an optimal algorithm can be used for the appropriate situation.

According to another preferred development, it is provided that, on the basis of the determined safety integrity level for the plurality of safety-related vehicle functions, fourth data, in particular a control signal, is generated to set at least one limit value of an object detector. This may advantageously reduce erroneous object detection.

According to another preferred development, it is provided that, on the basis of the determined safety integrity level for the plurality of safety-related vehicle functions, fifth data, in particular a control signal for selecting a controller, in particular for carrying out the safety-related vehicle functions, is generated. This may be performed if multiple systems or controllers are available for the same perception function.

According to another preferred further development, it is provided that the at least one infrastructure data signal may be provided prior to or when traversing a section of the path detected by vehicle sensors. Thus, the at least one provided infrastructure data signal may assist in determining the safety integrity level for the plurality of safety-related vehicle functions.

The described embodiments and further developments may be combined with one another as desired.

Further possible configurations, refinements, and implementations of the invention also comprise not explicitly mentioned combinations of features of the invention described above or below with respect to exemplary embodiments.

### BRIEF DESCRIPTION OF THE DRAWINGS

The accompanying drawings are intended to provide a better understanding of the embodiments of the invention. They illustrate embodiments and, in connection with the description, serve to explain principles and concepts of the invention.

Other embodiments and many of the mentioned advantages become apparent from the drawings. The illustrated elements of the drawings are not necessarily shown to scale with respect to one another.

The figures show:

FIG. 1 a flow chart of a computer-implemented method for determining a required safety integrity level of a safety-related vehicle function of a vehicle according to a preferred embodiment of the invention; and

FIG. 2 a schematic diagram of a controller for determining a required safety integrity level for a safety-related vehicle function of a vehicle according to the preferred embodiment of the invention.

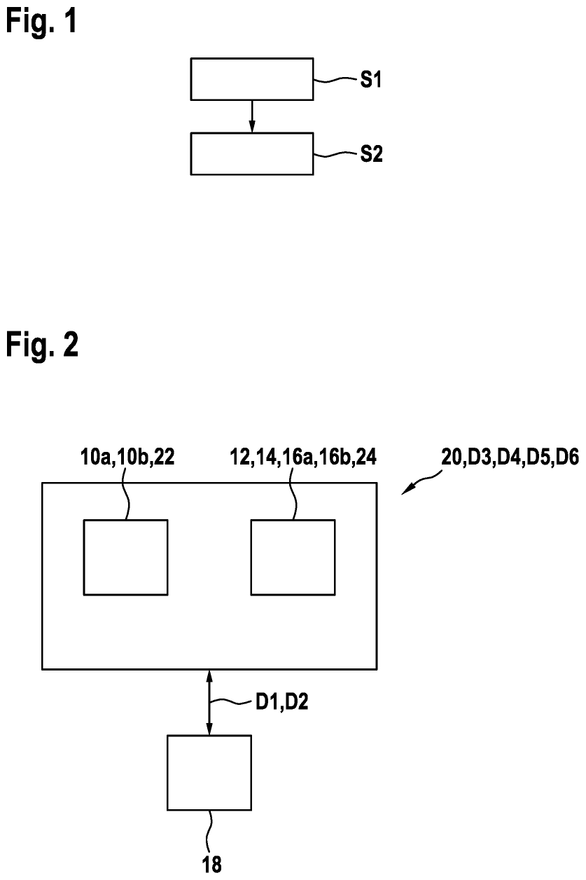

The computer-implemented method shown in FIG. 1 for determining a required safety integrity level 14 for safety-related vehicle functions 12 of a model of the surroundings of a vehicle, said model having a plurality of safety-related vehicle functions 12.

The method comprises providing S1 at least one infrastructure data signal 10a which represents infrastructure data and at least one vehicle sensor data signal 10b which represents vehicle sensor data, each piece of vehicle sensor data being determined for the plurality of safety-related vehicle functions 12.

Furthermore, the method comprises determining S2 a safety integrity level 14 for the plurality of safety-related vehicle functions 12 on the basis of the provided at least one infrastructure data signal 10a and the at least one vehicle sensor data signal 10b, wherein a first weighting 16a is added to the at least one vehicle sensor data signal 10b, and a second weighting 16b is added to the at least one infrastructure data signal 10a in order to determine the safety integrity level 14 for the plurality of safety-related vehicle functions 12.

The at least one infrastructure data signal 10a further includes information as to which regional areas have which safety integrity level 14. Furthermore, the at least one infrastructure data signal 10a comprises information about static obstacles, a traffic infrastructure, and/or dynamic objects. The at least one infrastructure data signal 10a also comprises information about a type of objects occurring with a predetermined probability in regional areas and a type of objects not occurring with a predetermined probability in regional areas. Additionally, the at least one infrastructure data signal 10a comprises information about a traffic density, a time, weather, light conditions, and/or a sun position.

On the basis of the determined safety integrity level 14 for the plurality of safety-related vehicle functions 12, first data D1, in particular, a control signal for controlling at least one vehicle sensor 18, is generated which represents the sensor modalities, in particular video, radar, lidar, ultrasonic, and/or microphone, with which regional areas of the surroundings of the vehicle are to be covered by vehicle sensors 18.

Furthermore, on the basis of the determined safety integrity level 14 for the plurality of safety-related vehicle functions 12, second data D2, in particular a control signal for controlling at least one vehicle sensor 18, is generated which represents the sensor redundancy, sensor resolution, and/or sensor measurement frequency with which regional areas of the vehicle's environment are to be covered.

Furthermore, on the basis of the determined safety integrity level 14 for the plurality of safety-related vehicle functions 12, third data D3, in particular a control signal, is generated for weighting perception functions, object models, and/or movement models regarding their suitability for sensing vehicle surroundings.

Furthermore, on the basis of the determined safety integrity level 14 for the plurality of safety-related vehicle functions 12, fourth data D4, in particular a control signal, is generated to select an algorithm type, in particular a Kalman filter or a deep learning based algorithm.

On the basis of the determined safety integrity level 14 for the plurality of safety-related vehicle functions 12, fifth data D5, in particular a control signal, is also generated to set at least one limit value of an object detector. Furthermore, on the basis of the determined safety integrity level 14 for the plurality of safety-related vehicle functions 12, sixth data D6, in particular a control signal for selecting a controller, in particular for carrying out the safety-related vehicle functions 12, is generated. The at least one infrastructure data signal 10a is further provided before or when traversing a path portion sensed by vehicle sensors 18.

FIG. 2 shows schematic diagram of a controller for determining a required safety integrity level 14 for a safety-related vehicle function 12 of a vehicle according to the preferred embodiment of the invention.

The controller 20 comprises a first means 22 for providing at least one infrastructure data signal 10a which represents infrastructure data and at least one vehicle sensor data signal 10b which represents vehicle sensor data, each piece of vehicle sensor data being determined for the plurality of safety-related vehicle functions 12.

Furthermore, the controller 20 comprises a second means 24 for determining a required safety integrity level 14 for the plurality of safety-related vehicle functions 12 on the basis of the provided at least one infrastructure data signal 10a and the at least one vehicle sensor data signal 10b, wherein the second means 24 is configured to add a first weighting 16a to the at least one vehicle sensor data signal 10b, and a second weighting 16b to the at least one infrastructure data signal 10a in order to determine the required safety integrity level 14 for the plurality of safety-related vehicle functions 12.

1. A computer-implemented method for determining a required safety integrity level for safety-related vehicle functions of a model of surroundings of a vehicle, the model having a plurality of safety-related vehicle functions the method comprising:
providing (i) at least one infrastructure data signal which represents infrastructure data, and (ii) at least one vehicle sensor data signal which represents vehicle sensor data, each piece of vehicle sensor data being determined for the plurality of safety-related vehicle functions; and
determining a safety integrity level for the plurality of safety-related vehicle functions based on the provided at least one infrastructure data signal and the at least one vehicle sensor data signal,
wherein a first weighting is added to the vehicle sensor data signal, and a second weighting is added to the infrastructure data signal in order to determine the required safety integrity level for the plurality of safety-related vehicle functions.

2. The computer-implemented method according to claim 1, wherein the at least one infrastructure data signal comprises information as to which regional areas of the surrounding of the vehicle have which safety integrity level.

3. The computer-implemented method according to claim 1, wherein the at least one infrastructure data signal comprises information about static obstacles, a traffic infrastructure, and/or dynamic objects.

4. The computer-implemented method according to claim 1, wherein the at least one infrastructure data signal comprises information about (i) a type of objects occurring with a predetermined probability in regional areas of the surroundings of the vehicle, and (ii) a type of objects not occurring with a predetermined probability in regional areas of the surroundings of the vehicle.

5. The computer-implemented method according to claim 1, wherein the at least one infrastructure data signal comprises information about a traffic density, a time, weather, light conditions, and/or a sun position.

6. The computer-implemented method according to claim 1, wherein, based on the determined safety integrity level for the plurality of safety-related vehicle functions, first data, including a control signal for controlling at least one vehicle sensor, is generated which represents sensor modalities, including video, radar, lidar, ultrasonic, and/or microphone, with which regional areas of the surroundings of the vehicle are to be covered by vehicle sensors

7. The computer-implemented method according to claim 1, wherein, based on the determined safety integrity level for the plurality of safety-related vehicle functions, second data, including a control signal for controlling at least one vehicle sensor, is generated which represents sensor redundancy, sensor resolution, and/or sensor measurement frequency, with which regional areas of the surroundings of the vehicle are to be covered.

8. The computer-implemented method according to claim 1, wherein, based on of the determined safety integrity level for the plurality of safety-related vehicle functions third data, including a control signal, is generated for weighting perception functions, object models, and/or movement models regarding their suitability for sensing vehicle surroundings.

9. The computer-implemented method according to claim 1, wherein, based on the determined safety integrity level for the plurality of safety-related vehicle functions, fourth data, including a control signal, is generated to select an algorithm type, in particular a Kalman filter or a deep learning based algorithm.

10. The computer-implemented method according to claim 1, wherein, based on the determined safety integrity level for the plurality of safety-related vehicle functions, fifth data, including a control signal, is generated to set at least one limit value of an object detector.

11. The computer-implemented method according to claim 1, wherein, based on the determined safety integrity level for the plurality of safety-related vehicle functions, sixth data, including a control signal for selecting a controller for carrying out the safety-related vehicle functions, is generated.

12. The computer-implemented method according to claim 1, wherein the at least one infrastructure data signal is provided before or when traversing a path portion sensed by vehicle sensors.

13. A controller for determining a required safety integrity level for safety-related vehicle functions of a model of surroundings of a vehicle, the model having a plurality of safety-related vehicle functions. the controller configured:
to provide (i) at least one infrastructure data signal which represents infrastructure data, and (ii) at least one vehicle sensor data signal which represents vehicle sensor data, each piece of vehicle sensor data being determined for the plurality of safety-related vehicle functions; and
to determine a safety integrity level for the plurality of safety-related vehicle functions based on the provided at least one infrastructure data signal and the at least one vehicle sensor data signal,
wherein the controller is configured such that a first weighting is added to the at least one vehicle sensor data signal, and a second weighting is added to the infrastructure data signal in order to determine the required safety integrity level for the plurality of safety-related vehicle functions.

14. The computer-implemented method according to claim 1, wherein a computer program comprises program code for performing the method when the computer program is executed on a computer.

15. A non-transitory computer-readable data carrier comprising the program code according to claim 14.
